(19) United States
(12) Patent Application Publication
(10) Pub. No.: US 2026/0181325 A1
(43) Pub. Date: Jun. 25, 2026

(54) SYSTEM AND METHOD FOR SOUND REPRODUCTION

(71) Applicant: HARMAN BECKER AUTOMOTIVE SYSTEMS, INC., Novi, MI (US)

(72) Inventors: Sreejith GOPAKUMAR, Pfaffenhofen an der Ilm (DE); Friedrich VON TÜRCKHEIM, Hamburg (DE)

(21) Appl. No.: 19/425,324

(22) Filed: Dec. 18, 2025

(30) Foreign Application Priority Data
Dec. 23, 2024 (EP) 24222750.2

(51) Int. Cl. H04R 3/12; H04R 1/40

(52) U.S. Cl. CPC H04R 3/12; H04R 1/403; H04R 2201/40; H04R 2430/01

(57) ABSTRACT

A sound reproduction method comprises receiving an input audio signal representative of audio content to be reproduced; generating at least two sound zones using multiple loudspeakers, the multiple loudspeakers being configured, positioned and operated to spatially limit audibility of audio content to be reproduced to one of the at least two sound zones, and reproducing in the one of the at least two sound zones the audio content to be reproduced using at least some of the multiple loudspeakers, wherein the at least some of the multiple loudspeakers are configured, positioned and operated to generate from the input audio signal sound that creates three-dimensional audio effects, the three-dimensional audio effects including placement of virtual sound sources anywhere in a three-dimensional space, and the three-dimensional space being the one of the at least two sound zones.

### CROSS-REFERENCE TO RELATED APPLICATIONS

This application claims priority benefit to European Patent Application Number 24222750.2 entitled “SYSTEM AND METHOD FOR SOUND REPRODUCTION,” filed Dec. 23, 2024, the contents of which are incorporated herein by reference in its entirety.

### BACKGROUND

### Field of the Various Embodiments

The disclosure relates to a system and method (generally referred to as a “system”) for sound reproduction.

### Description of the Related Art

Three-dimensional (3D) audio rendering technologies play a vital role in delivering spatial and immersive audio. Technologies are known that present to the user an authentic and immersive sound. However, a significant challenge posed by 3D audio rendering in listening rooms such as vehicle (e.g. car) interiors, is that the best listening experience is often confined to certain positions or “sweet-spots”. For example, common 3D audio rendering in a car interior offers the best audio experience typically for those in the front seats or in a specially designated “very important person” (VIP) seat. There is a desire to overcome this limitation.

### SUMMARY

A sound reproduction method and system include the operations of receiving one or more input audio signals representative of audio content to be reproduced; generating at least two sound zones using multiple loudspeakers, the multiple loudspeakers being configured, positioned and operated to spatially limit audibility of audio content to be reproduced to at least one of the at least two sound zones; and reproducing in the one of the at least two sound zones the audio content to be reproduced using at least some of the multiple loudspeakers, wherein the at least some of the multiple loudspeakers are configured, positioned and operated to generate from the input audio signal sound that creates three-dimensional audio effects, the three-dimensional audio effects including placement of virtual sound sources anywhere in a three-dimensional space, and the three-dimensional space being the one of the at least two sound zones.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating an example audio system that includes an audio processing system and loudspeakers.

FIG. 2 is a block diagram illustrating an example process structure of an audio reproduction method applicable in the audio processing system shown in FIG. 1.

FIG. 3 is a top view of a vehicle cabin with two individual sound zones.

FIG. 4 is a schematic diagram illustrating a 2×2 transaural stereo system.

FIG. 5 is a top view of a vehicle interior with a plurality of loudspeakers arranged in each individual sound zone around a user's head position.

FIG. 6 is a schematic diagram illustrating an example of a 3D audio rendering method that uses upmixing, including panning estimation, direct/ambience decomposition and repanning.

FIG. 7 is a three-dimensional view illustrating a loudspeaker set-up of a nine-channel 3D audio reproduction system.

FIG. 8 is a schematic diagram illustrating a five-channel audio system with virtual source distribution using repanning.

FIG. 9 is a schematic diagram illustrating an example original source extraction method using spatial extraction.

FIG. 10 is a block diagram illustrating a process for generating an ambience that uses generating virtual venues within a listening room.

FIG. 11 is a flow chart illustrating a method for generating the virtual venues within the listening room using the process structure shown in FIG. 10.

FIG. 12 is a block diagram illustrating an example user preference handling process using a graphical interface and machine learning.

FIG. 13 is a flow chart illustrating an example work flow of the process structure shown in FIG. 2.

### DETAILED DESCRIPTION

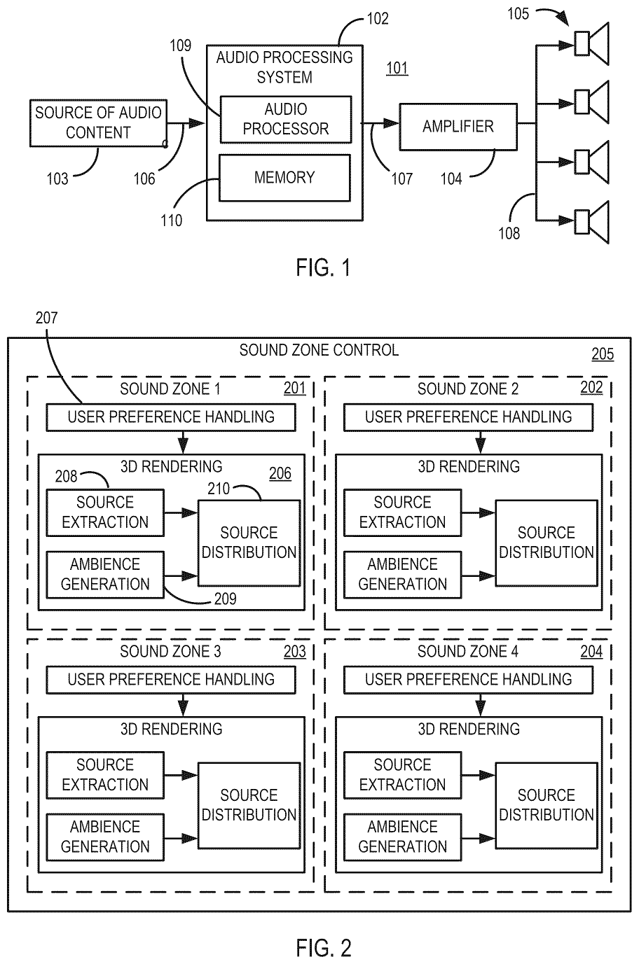

FIG. 1 is an example audio system 101 that includes an audio processing system 102. The audio system 101 may also include at least one source of audio content 103, a multi-channel amplifier 104 and a plurality of loudspeakers 105. The audio system 101 may be any system capable of producing audible audio content. Example audio systems 101 include a vehicle audio system, a stationary consumer audio system such as a home theater system, an audio system for a multimedia system such as a movie theater or television, a multi-room audio system, a public address system such as in a stadium or convention center, an outdoor audio system, or any other venue in which it is desired to reproduce audible audio sound.

The source of audio content 103 may be any form of one or more devices capable of generating and outputting different audio signals on one or more channels. Examples of the source of audio content 103 include a media player, such as a compact disc, or video disc player, a video system, a radio, a cassette tape player, a wireless or wireline communication device, a navigation system, a personal computer, a codec such as an MP3 player or any other form of audio related device capable of outputting audio signals.

In FIG. 1, the source of audio content 103 produces two or more audio signals on respective audio input channels 106 from source material such as pre-recorded audible sound. The audio signals may be audio input signals produced by the source of audio content 103, and may be analog signals based on analog source material, or may be digital signals based on digital source material. Accordingly, the source of audio content 103 may include signal conversion capability such as analog-to-digital or digital-to-analog converters. In one example, the source of audio content 103 may produce stereo audio signals consisting of two substantially different audio signals representative of a right and a left channel provided on two audio input channels 110. In another example, the source of audio content 103 may produce greater than two audio signals on greater than two audio input channels 106, such as 5.1 surround, 6.1 surround, 7.1 surround or any other number of different audio signals produced on a respective same number of audio input channels 106.

The amplifier 104 may be any circuit or standalone device that receives audio input signals of relatively small magnitude, and outputs similar audio signals of relatively larger magnitude. Two or more audio input signals may be received on two or more amplifier input channels 107 and output on two or more audio output channels 108. In addition to amplification of the amplitude of the audio signals, the amplifier 104 may also include signal processing capability to shift phase, adjust frequency equalization, adjust delay or perform any other form of manipulation or adjustment of the audio signals. Also, the amplifier 104 may include the capability to adjust the volume, balance and/or fade of the audio signals provided on the audio output channels 108. In an alternative example, the amplifier may be omitted when the audio output channels serve as the inputs to another audio device. In still other examples, the loudspeakers 105 may include amplifiers, such as when the loudspeakers 105 are self-powered loudspeakers.

The loudspeakers 105 may be positioned in a listening space such as a room, a vehicle, or in any other space where the loudspeakers 105 can be operated. The loudspeakers 105 may be any size and may operate over any range of frequency. Each audio output channel 108 may supply a signal to drive one or more loudspeakers 105. Each of the loudspeakers 105 may include a single transducer, or multiple transducers. The loudspeakers 105 may also be operated in different frequency ranges such as a subwoofer, a woofer, a midrange and a tweeter. Two or more loudspeakers 105 may be included in the audio system 101.

The audio processing system 102 may receive the audio input signals from the source of audio content 103 on the audio input channels 106. Following processing, the audio processing system 102 provides processed audio signals on the amplifier input channels 107. The audio processing system 102 may be a separate unit or may be combined with the source of audio content 103, the amplifier 104 and/or the loudspeakers 105. Also, in other examples, the audio processing system 102 may communicate over a network or communication bus to interface with the source of audio content 103, the audio amplifier 104, the loudspeakers 105 and/or any other device or mechanism (including other audio processing systems 102).

One or more audio processors 109 may be included in the audio processing system 102. The one or more audio processors 109 may be one or more computing devices capable of processing audio and/or video signals, such as a computer processor, microprocessor, a digital signal processor, or any other device, series of devices or other mechanisms capable of performing logical operations. The one or more audio processors 109 may operate in association with a memory 110 to execute instructions stored in the memory 110. The instructions may be in the form of software, firmware, computer code, or some combination thereof, and when executed by the one or more audio processors 109 may provide the functionality of the audio processing system 102. The memory 110 may be any form of one or more data storage devices, such as volatile memory, non-volatile memory, electronic memory, magnetic memory, optical memory, or any other form of data storage device. In addition to instructions, operational parameters and data may also be stored in the memory 110. The audio processing system 102 may also include electronic devices, electro-mechanical devices, or mechanical devices such as devices for conversion between analog and digital signals, filters, a user interface, a communications port, and/or any other functionality to operate and be accessible to a user and/or programmer within the audio system 101.

During operation, the audio processing system 102 receives and processes the signals on the audio input channels 106. In general, during processing of the signals on the audio input channels 106, the one or more audio processors 109 identify a plurality of perceptual locations of each of a plurality of sources of audible sound represented within an audio input signal. The perceptual locations are representative of physical locations of the respective sources of audible sound within a user perceived sound stage. Accordingly, if a user (listener) were present at a live performance occurring on an actual stage, the perceptual locations would align with the locations on the stage of the performers, such as guitarists, drummers, singers and any other performers or objects producing sound within the audio signals.

The audio processor 109 decomposes the audio input signals into a set of spatial audio streams, or spatial slices, each containing audio content from a respective one (at least) of the perceptual locations. Any sound sources that are co-located within a given perceived location may be included in the same spatial audio stream. Any number of different spatial audio streams may be created across the user perceived soundstage. The spatial audio streams may be independently processed with the audio processor 109.

During operation, the audio processor 109 may generate a plurality of filters for each of a plurality of respective output channels based on the identified perceptual locations of the respective sources of audible sound. The audio processor 109 may apply the filters to the audio input signal to generate the spatial audio streams. The spatial audio streams may be independently processed. Following processing, the spatial audio streams may be assembled or otherwise recombined to generate an audio output signal having a plurality of respective audio output channels. The audio output channels are provided on the amplifier input lines, i.e., audio output channels 108. The audio processing system 102 may provide more or fewer audio output channels than the number of input channels included in the audio input signal. Alternatively, the audio processing system 102 may provide the same number of audio output channels as are provided as input channels.

Further, the audio processor 109 may process the audio signals to be output on the amplifier input channels 107 so that the audibility of different audio contents when reproduced via the loudspeakers 105 is spatially limited to different sound zones. For example, multiple users in the same room are supplied with different audio content by the loudspeakers 105 without the need of headphones or constructional acoustic barriers.

FIG. 2 shows an example process structure with processing blocks and their interconnections implemented in the audio processing system 102 shown in FIG. 1 to allow every user of a group of users in a location such as a room to experience three-dimensional (3D) audio rendering in his/her unique style. The example process structure includes the generation of four sound zones 201-204 resembling the audio rendering scenario in a vehicle interior with four seating positions. For the sake of simplicity, all four zones 201-204 are the same apart from their different positions, but they can be different if so desired. In the following, only one zone 201 is described in detail as representative of all zones 201-204. The process structure includes a sound zone control block 205, which is shown in FIG. 2 as being common to all sound zones 201-204, but may also be present in each of the sound zones 201-204. The sound zone 201 (and each of the other sound zones 202-204) includes a 3D rendering block 206 and a user preference evaluation block 207. As used herein, the term “block” or “blocks” is defined as software (computer code, instructions) or hardware (such as circuits, electrical components and/or logic), or a combination of software and hardware.

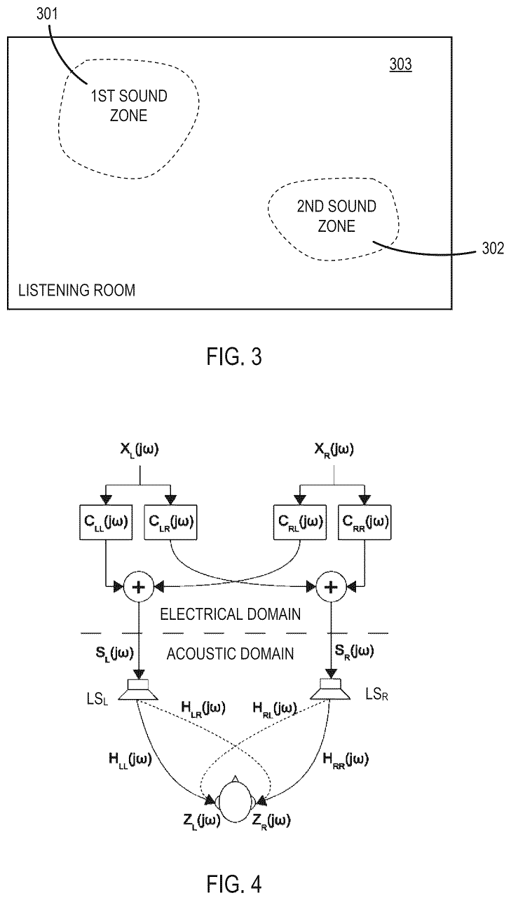

The sound zone control block 205 is designed to establish and control the sound zone 201 (and the other sound zones 202-204) using multiple loudspeakers in the vehicle interior in connection with specific signal processing including filtering and delaying the signals to be reproduced. The sound zone control block 205 uses not only active noise cancelling technologies but also sound guiding technologies to focus sound in a designated zone, and at the same time minimize sound energy in other zones. This may also employ multiple microphones (not shown in FIG. 2) for sound control. For individual sound zones within a listening environment, different sounds are reproduced in each zone. In order to realize individual sound zones, it is necessary to adjust the response of multiple sound sources to approximate a desired sound field in the reproduction zone without interfering with other individual sound zones. An example of how individual sound zones are realized is described below in connection with FIGS. 3 and 4, and is detailed in U.S. Pat. No. 9,338,554, assigned to the assignee of the present disclosure, and incorporated herein by reference.

For example, the 3D rendering block 206 generates an output multi-channel 3D audio signal from an input stereo signal, which is a two-channel audio, by way of an source extraction block 208, an ambience generation block 209, and a source distribution block 210. The blocks 208-210 may be integrated in an up-mixing process (not shown in FIG. 2). The source extraction block 208 is designed to extract the sources occurring in the input stereo signal (original sources) therefrom, e.g., to extract the center signal and the residual signals from the input stereo signal using technologies such as center extraction, vocals extraction, instruments extraction, etc. The ambience generation block 209 provides a variety of ambience settings controllable by the user via the user preference handling block 207, and includes, for example, the generation of early reflections and reverberations, delays, desired sound pressure level patterns, and tonality. The source distribution block 210 for positioning the detected sources in the output 3D audio signal, and is designed for deriving the panning coefficients for virtually positioning the extracted original sources in the sound to be reproduced based on the user preferences. Ambience stands for the (ambient) sounds of a given location or space. It is the opposite of “silence”. Ambience is similar to presence, but is distinguished by the existence of explicit background noise in ambience.

The user preference handling block 207 executes, for example, a machine learning (ML) based algorithm which maps input user preferences related to the virtual source distribution to corresponding parameters of the 3D rendering block 206. The machine learning based algorithm may be trained with a large variety of audio signals and for a very large number of users. The user preference evaluation block 208 may perform at least one of retrieving source distribution related information specified by the user, mapping the user information to appropriate audio signal parameters using the machine learning algorithm, and feeding information, e.g., regarding the position of each virtual source as desired by the user, to the 3D rendering block 206. The sound zone control block 205, the 3D rendering block 206 and the user preference evaluation block 208 can be implemented in a variety of ways, some of which are described below in detail.

The concept of two (or more) individual sound zones in a listening room (e.g., vehicle interior) is presented by means of an example sound zone setup illustrated in FIG. 3. Two different sound zones, a first sound zone 301 and a second sound zone 302 are arranged at two different locations in a listening room 303. In the first sound zone 301, a first audio signal (e.g., speech) is reproduced, while in sound zone 302, a second audio signal (e.g., music) is reproduced. The spatial position of the two zones 301 and 302 may be fixed or adaptively changed (e.g., dependent on the respective user's position). The goal is to minimize crosstalk from the first audio signal (associated with the first sound zone 301) to the second sound zone 302 and from the second audio signal (associated with the second sound zone 302) to the first sound zone 301. It is noted, that FIG. 3 illustrates a top view. The sound zones 301, 302 actually encompass a three-dimensional volume including the head (particularly the ears) of the user.

FIG. 4 illustrates a basic signal flow structure of a so-called “transaural stereo” arrangement. In the depicted system, the audio signals and transfer functions are frequency domain signals and functions, which have corresponding time domain signals and functions, respectively. The left input audio signal XL(jω) and the right input audio signal XR(jω), which may be provided, e.g., by a radio receiver, are pre-filtered by so-called inverse filters CLL(jω), CLR(jω), CRL(jω) and CRR(jω), and the filter output signals are combined as illustrated in FIG. 2; that is, signal SL(jω) supplied to a left loudspeaker LSL can be calculated as:

SL(jω)=CLL(jω)·XL(jω)+CRL(jω)·XR(jω), (1)
and signal SR(jω) supplied to a right loudspeaker LSR can be calculated as:

SR(jω)=CLR(jω)·XL(jω)+CRR(jω)·XR(jω). (2)

The loudspeakers radiate signals SL(jω) and SR(jω) as acoustic signals that propagate to the left and right ears of the user, respectively. The sound signals actually present at the user's left and right ears are denoted as ZL(jω) and ZR(jω), respectively, wherein:

ZL(jω)=HLL(jω)·SL(jω)+HRL(jω)·SR(jω), (3)

and

ZR(jω)=HLR(jω)·SL(jω)+HRR(jω)·SR(jω). (4)

In equations 3 and 4, a transfer function Hij(jω), denotes the room impulse response (RIR) in the frequency domain, i.e., the transfer function from each of loudspeakers LSi and LSj to the left and right ears of the user. The indices i and j may be each “L” or “R”, in which “L” and “R” refer to the left and right loudspeakers and ears, respectively. The above equations 1-4 may be rewritten in matrix form, wherein equations 1 and 2 may be combined into:

S(jω)=C(jω)·X(jω), (5)
and equations 3 and 4 may be combined into:

Z(jω)=H(jω)·S(jω), (6)
wherein X(jω) is a vector composed of the input signals, i.e., X(jω)=[XL(jω), XR(jω)]T, Sow) is a vector composed of the loudspeaker signals, i.e., S(jω)=[SL(jω), SR(jω)]T, C(jω) is a matrix representing the four filter transfer functions CLL(jω), CRL(jω), CLR(jω) and CRR(jω) and H(jω) is a matrix representing the four room impulse responses in the frequency domain HLL(jω), HRL(jω), HLR(jω) and HRR(jω). Combining equations 5 and 6 yields:

Z(jω)=H(jω)·C(jω)·X(jω). (7)

From the above equation 6, it can be seen that:

C(jω)=H−1(jω)·e−jωτ, (8)
that is, when filter matrix C(jω) is equal to the inverse of matrix H(jω) of room impulse responses in frequency domain H−1(jω) plus an additionally delay T (which represents at least the acoustic delay), then signal ZL(jω) arriving at the left ear of the user is equal to the left input signal XL(jω) and signal ZR(jω) arriving at the right ear of the user is equal to the right input signal XR(jω), wherein the signals ZL(jω) and ZR(jω) are delayed by the mentioned delay T as compared to the input signals XL(jω) and XR(jω), respectively. That is:

Z(jω)=X(jω)·e−jωτ. (9)

As can be seen from equation 7 and 8, the problem of designing a transaural stereo reproduction system is—from a mathematical point of view—a problem of inverting the transfer function matrix H(jω), which represents the room impulse responses in the frequency domain (RIR matrix). Various methods are known for matrix inversion. For example, the inverse may be determined as follows:

C(jω)=det(H)−1·adj(H(jω)), (10)
which is a consequence of Cramer's rule applied to equation 8 (the delay is neglected in equation 10). The expression adj(H (jω)) represents the adjugate matrix of the RIR matrix H(jω). One can see that the pre-filtering may be done in two stages, wherein the filter transfer function adj (H (jω)) ensures a damping of the crosstalk and the filter transfer function det(H)−1 compensates for the linear distortions caused by transfer function adj(H(jω)). The adjugate matrix adj(H (jω)) always results in a causal filter transfer function, whereas the compensation filter G(jω))=det(H)−1 may be more difficult to design. Nevertheless, several known methods for inverse filter design may be appropriate.

In the example signal flow structure shown in FIG. 4, the left ear (signal ZL) may be regarded as being located in a first sound zone and the right ear (signal ZR) may be regarded as being located in a second sound zone. The arrangement depicted in FIG. 4 may provide a sufficient crosstalk damping so that, substantially, input signal XL is reproduced only in the first sound zone (left ear) and input signal XR is reproduced only in the second sound zone (right ear). This concept may be generalized (a sound zone is not necessarily associated with a user's ear) and extended to a multi-dimensional case (more than two sound zones), provided that the system comprises at least as many loudspeakers as individual sound zones.

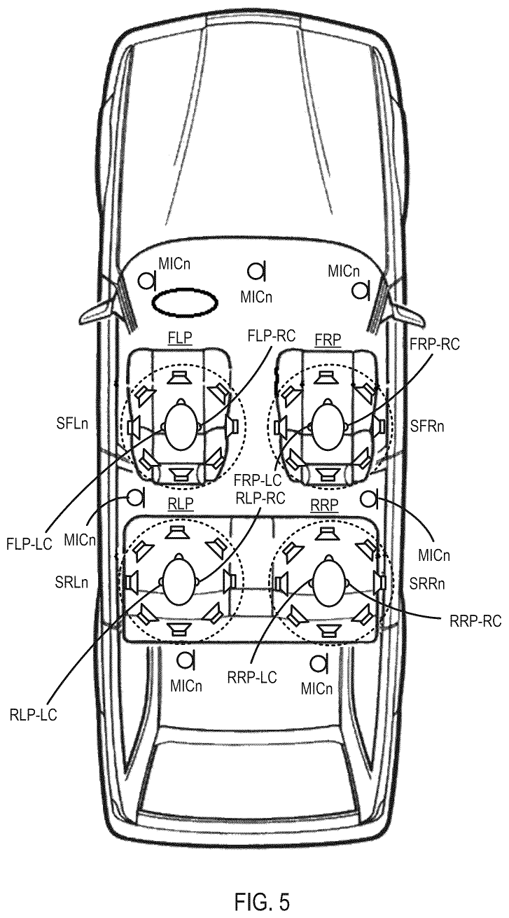

FIG. 5 shows an example audio system in a listening environment such as a vehicle interior having four sound zones 501-504 that may be subjected to a signal processing arrangement of one or more embodiments of the present disclosure. The example system shown in FIG. 5 relies on a plurality of loudspeakers positioned throughout the vehicle. For example, the loudspeakers may be positioned in a headrest, instrument panel, door, rear side of a front seat and vehicle headliner at or around one or more listening positions. Incoming audio signals are processed and the loudspeaker output is controlled to personalize the sound for each zone. In FIG. 5, a top view of a vehicle interior 505 is shown with an exemplary four listening positions: front left listening position FLP, front right listening position FRP, rear left listening position RLP and rear right listening position RRP. A stereo signal with left and right channels is reproduced so that a stereo audio signal is received at each listening position: front left position left and right channels FLP-LC and FLP-RC, front right position left and right channels FRP-LC and FRP-RC, rear left position left and right channels RLP-LC and RLP-RC, and rear right position left and right channels RRP-LC and RRP-RC. Each channel may include a loudspeaker or a group of loudspeakers of the same or different type, such as woofers, midrange loudspeakers and tweeters. Loudspeakers are integrated into the headliner, left and right above the listening positions FLP, FRP, RLP and RRP. It is advantageous for a distance between the user's ears and the corresponding loudspeakers be kept as short as possible to increase the natural isolation of speakers between zones. Additionally, a vehicle may be equipped with midrange and high frequency speakers (both not shown) typically located in the front, rear and sides of the vehicle, such as in the instrument panel, vehicle floor, vehicle door panels, and/or trunk space. The vehicle may also be equipped with a plurality of microphones MICn, typically located in the top, front, rear and lateral surfaces of the vehicle interior, such as in the instrument panel, vehicle ceiling, vehicle door panels, and rear shelf.

The individual sound zone algorithm has been applied as a solution for mono audio. One or more embodiments of the present disclosure utilizes such individual sound zone algorithms for bass frequency processing of the audio by applying a low pass filter and maintains a remainder of the frequency band (mid to high frequency), including volume control, in stereo and/or surround sound. Components of the audio signal are separated using a high pass filter to keep the stereo/surround information to be distributed to speakers. According to one or more examples, loudspeakers in the headrests also keep their stereo configuration but the low frequency components are passed to mono. In this regard, the audio content may be played to each of the zones at different volumes, depending on a volume control set by a user at each individual sound zone. Ideally, when a user in one zone adjusts their volume, the users in other zones will not detect a difference in the volume of their own individual sound zone.

3D audio effects are a group of sound effects that manipulate the sound produced by stereo speakers, surround-sound speakers, speaker-arrays, or headphones. This frequently involves the virtual placement of sound sources anywhere in three-dimensional space, not only in front but also behind, above or below the user. 3D audio (processing) is the spatial domain convolution of sound waves. It is the phenomenon of transforming sound waves (e.g., using head-related transfer function filtering and cross talk cancellation techniques) to mimic natural sound waves, which emanate from a point in a 3D space. It allows trickery of the brain using the ears and auditory nerves, pretending to place different sounds in different 3D locations upon hearing the sounds, even though the sounds are produced by two or more speakers at fixed locations.

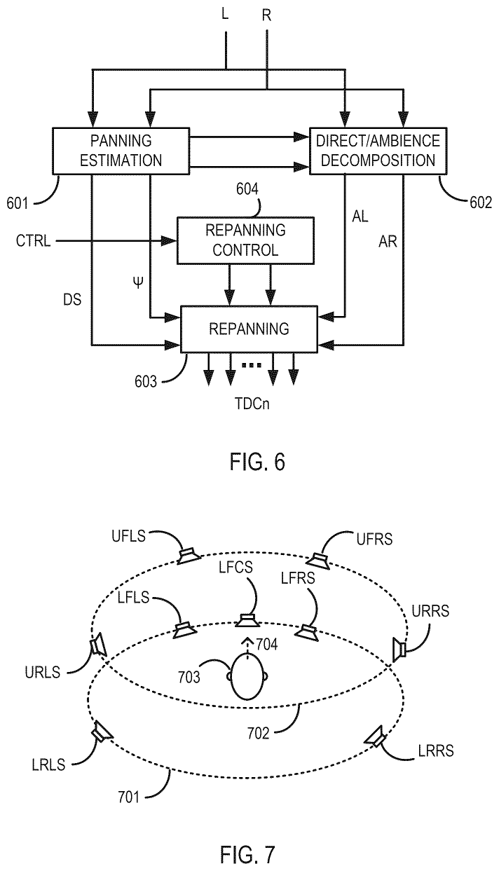

An up-mixing technology including source extraction, ambience generation and source distribution may be used for 3D audio generation as depicted in FIG. 6. Up-mixing is the process of generating additional loudspeaker signals from source material with fewer channels than available loudspeakers, which is in many cases converting two-channel recordings into multi-channel formats. For example, an up-mixing algorithm may be based on the description of a stereo recording having two channels L, R as the weighted sum of direct signal sources overlaid with an uncorrelated ambient signal as shown in FIG. 6 and may include the following processing blocks operating in the time or frequency domain: In a panning estimation block 601 which may be operated as a source extraction block, the azimuth position or panning coefficients of the original sources, i.e., the sources in the original (stereo) recording, are estimated under the assumption that only one dominant source is active at a single time-frequency instant. The panning estimation block 601 outputs, for example a dry signal DS and the direction from which the dry signal DS originates represented by an azimuth signal 4. In a direct/ambience decomposition block 602, which may be operated as an ambience generation block, the direct and ambient components are separated with the knowledge of the panning coefficients to provide an ambience signal AL for the left channel L and an ambience signal AR for the right channel. Based on the estimated signals DS, 4, AL and AR the original content targeting any desired virtual loudspeaker configuration is remixed in a repanning block 603, which may be operated as a source distribution block, according to user preferences input into and processed by a repanning control block 604. The difference between a dry signal and a wet signal is that the wet signal is the processed or affected part of the sound, while the dry signal is the original or unaffected part. For example, if reverb is applied to a vocal track, the wet signal represents the reverberated sound, and the dry signal represents the vocal sound without reverb.

For example, two stereo input channels L, R may be up-mixed to a nine-channel signal, each channel may drive one loudspeaker or group of loudspeakers LFCS, LFLS, LFRS, LRLS, LRRS, UFLS, UFRS, URLS, URRS as shown in FIG. 7. Five loudspeakers or group of loudspeakers LFCS, LFLS, LFRS, LRLS, LRRS are disposed along a first virtual circle 701 in a lower plane and the remaining four loudspeakers or group of loudspeakers UFLS, UFRS, URLS, URRS are disposed along a second virtual circle 702 in an upper plane, which is above the circle 701 in the lower plane. A user 703 may be positioned in the center of the lower circle 701 with a gaze direction 704 toward the center loudspeaker LFCS.

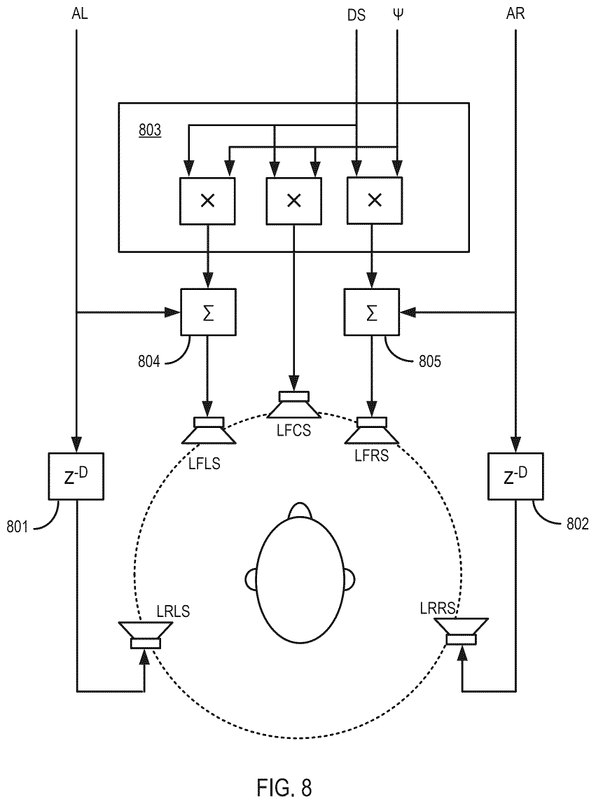

Looking now at the loudspeakers or group of loudspeakers LFCS, LFLS, LFRS, LRLS, LRRS in the lower plane only, the estimated signals DS, Ψ, AL and AR may be used to create a stereo to five-channel surround sound up-mix following a signal flow depicted in FIG. 8. The dry signal DS is repanned on the front loudspeakers LFCS, LFLS, LFRS by using, e.g., Vector Base Amplitude Panning (VBAP) 803 based on the azimuth signal Ψ, while the left and right ambient signals AL, AR are added (with adders 804, 805) to the signals for the front corner loudspeakers LFLS, LFRS and supplied to the rear corner loudspeakers LRLS, LRRS. In order to decorrelate the front from the rear, a short delay 801, 802 for each ambient signal AL, AR may be included between front and rear. Alternatively, more advanced (e.g., time-domain) decorrelators may be used.

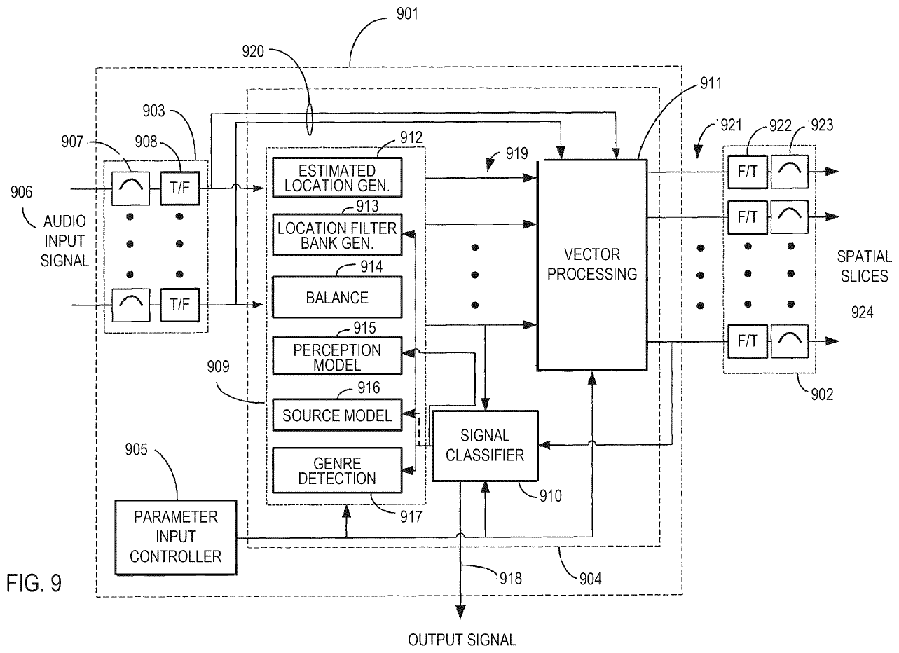

An example of a source extraction process is described below in connection with FIG. 9. and detailed in U.S. Pat. No. 9,372,251 B2, assigned to the assignee of the present disclosure, and incorporated herein by reference. FIG. 9 shows example functional processing blocks of an audio processing method operating in the frequency domain. The audio processing method includes an audio input signal dissection block 901 and a post-processing block 902. The audio input signal dissection block 901 includes an audio input pre-processing block 903, a sound source vector generation block 904, and a parameter input controller block 905. In other examples, additional or fewer blocks may be used to describe the functionality of the audio processing system.

In FIG. 9, the audio input pre-processing block 903 may receive audio input signals 906. The audio input signals 906 may be a stereo pair of input signals, multi channel audio input signals, such as 5 channel, 6 channel or 7 channel input signals, or any other number of audio input signals greater than or equal to two audio input signals. The audio input pre-processing block 903 may include any form of time domain to frequency domain conversion process. In FIG. 9, the audio input pre-processing block 903 includes a windowing block 907 and converter 908 for each of the audio input signals 906. The windowing block 907 and the converter 908 may perform overlapping window analysis to a block of time samples and converting the samples with Discrete Fourier Transform (DFT), or other transformation process. In other examples, processing of the audio input signals may be performed in the time domain, and the audio input pre-processing block 903 may be omitted from the audio input signal processing block 901, and may be replaced by a time domain filter bank.

The pre-processed (or not) audio input signals may be provided to the sound source vector generation block 904. The sound source vector generation block 904 may generate the sound source generation vectors (Ss). The sound source vector generation block 904 may include a gain vector generation block 909, a signal classifier block 910, and a vector processing block 911. The gain vector generation block 909 may generate gain location vectors for each of the spatial slices 924. Spatial slices 924 represent perceptual locations across the listener perceived sound stage at an instant in time. The listener perceived sound stage includes, for example, a left loudspeaker and a right loudspeaker that are generally symmetrical about a center. In other examples, other configurations of a listener perceived sound stage may be implemented, such as a surround sound listener perceived stage.

Generation of gain location vectors with the gain vector generation block 909 may include processing with an estimated location generation block 912, a locational filter bank generation block 913, a balance block 914, a perceptual model 915, a source model 916, and a genre detection block 917. The estimate location generation block 912 may calculate the estimated perceptual location values using Equation 1 as previously discussed. The locational filter bank generation block 913 may calculate the locational filter bank and the balance block may calculate sound source generation vectors (Ss).

The perceptual model 915 and the source model 916 may be used to improve processing to develop the gain location vectors with the estimated location generation block 912, the locational filter bank generation block 913, and the balance block 914. In general, the perceptual model 915 and the source model 916 may cooperatively operate to enable adjustments in calculation of the gain location vectors on a snapshot-by-snapshot basis to compensate for abrupt changes in the calculated locations of sources of audible sound within the user perceived sound stage. For example, the perceptual model 915 and the source model 916 may compensate for abrupt changes in the existence and amplitude of a particular sound source in the user perceived sound stage that could otherwise cause abrupt shifts in perceived location. The perceptual model may perform smoothing of the gain location vectors based on at least one of temporal-based auditory masking estimates, and frequency-based auditory masking estimates during generation of the gain location vectors over time (e.g. over a number of snapshots). The source model 916 may monitor the audio input signal and provide smoothing to avoid exceeding a predetermined rate of change in amplitude and frequency of the audio input signal over a predetermined number of snapshots.

Monitoring may be performed for each snapshot, or moment in time of the audio input signal on a frequency bin by frequency bin basis taking into account at least one of the previous snapshots. In one example, two previous snapshots are individually weighted with predetermined weighting factors, averaged and used for comparison to the current snapshot. The most recent previous snapshot may have a higher predetermined weighting than the older snapshot. Upon identification by the source model 916 of changes in amplitude or frequency that exceed the predetermined rate of change, the perceptual model 915 may automatically and dynamically smooth the gain values in the gain location vectors to reduce the rate of change in the perceived location of sources or audible sound, or audio sources, included in the perceived sound stage of the audio input signal. For example, when multiple audio sources are sometimes together in the same perceptual location, or spatial slice 924, and sometimes occupy different perceptual locations at different instants in time, smoothing may be used to avoid having audio sources appear to “jump” between perceptual locations. Such quick movements between perceptual locations may otherwise be perceived by a user as an audio source jumping from one of the loudspeakers being driven by a first output channel to another of the loudspeakers being driven by a second output channel.

Alternatively, or in addition, the source model 916 may be used to define the boundaries of the perceptual locations or spatial slices 924 where the perceptual locations are automatically adjustable in accordance with the audio sources identified in the audio input signal based on sources included in the source model 916. Thus, if an audio source is identified as being in more than one perceptual location, an area representative of a perceptual location may be increased or decreased by adjusting the boundaries of the perceptual location. For example, the area of a perceptual location may be widened by adjustment of the crossover points of filters in a locational filter bank (not shown) so that the entire audio source is in a single perceptual location. In another example, if two or more audio sources are determined to be in the same perceptual location, the boundaries of the perceptual location, or spatial slice 924 may be gradually reduced until the audio sources appear in separate spatial slices 924. Multiple audio sources in a single perceptual location may be identified by, for example, identifying sources in the source model that correspond to the different operational frequency ranges of the identified sources. The boundaries of other spatial slices 924 may also be automatically adjusted. As previously discussed, the boundaries of the perceptual locations may overlap, be spaced away from one another, or may be contiguously aligned.

The perceptual model 915 may also smooth over time the gain values included in the gain location vectors to maintain smooth transitions from one moment in time to the next. The source model 916 may include models of different audio sources included in the audio input signal. During operation, the source model 916 may monitor the audio input signal and regulate the smoothing processing with the perceptual model 915. As an example, the source model 916 may detect sudden onsets of a sound source such as a drum, and may cause the perceptual model 915 to reduce the amount of smoothing in order to capture the onset of the drum at a unique location in space rather than smear it across spatial slices 924. Using the models included in the source model 916, the perceptual model 915 may account for the physical characteristics of a sound source included in the audio input signal when deciding how much a given frequency band should be attenuated. Although illustrated in FIG. 9 as separate blocks, the perceptual model 915 and the source model 916 may be combined in other examples.

The genre detection block 917 may detect a genre of an audio input signal, such as classical music, jazz music, rock music, talk. The genre detection block 917 may analyze the audio input signal to classify the audio input signal. Alternatively, or in addition, the genre detection block 917 may receive and decode data included with the audio input signal to determine and classify the audio input signal as being a particular genre. The genre information determined by the genre detection block 917 may also be provided to the other blocks in the gain vector generation block 909. For example, in a surround sound application, the locational filter bank generation block 913 may receive indication from the genre detection block 917 that the genre is classical music and automatically adjust the locational filter bank by adjustment of the crossover points of the filters in the locational filter bank to avoid any portion of the audio input signal being output to the right rear and left rear audio output channels.

The signal classifier block 910 may operate on each of the perceptual locations (spatial slices) across the user perceived sound stage to identify one or more audio sources included in a respective one of the perceptual locations. The signal classifier block 910 may identify sound sources from the sound source vectors (Ss). For example, in a first one of the perceptual locations, the signal classifier block 910 may identify a respective audio source as a voice of a singer, in a second perceptual location the respective audio source may be identified as a particular musical instrument, such as a trumpet, in a third perceptual location multiple respective audio sources may be identified, such as a voice and a particular musical instrument, and in a fourth perceptual location in the user perceived sound stage the respective audio source may be identified as audience noise, such as applause. Identification of the audio sources may be based on signal analysis of the audible sound included in a particular perceptual location.

The signal classifier block 910 may base its identification of sound sources on received input information from the parameter input controller 905, output signals of the vector generation block 909, and/or output signals of the vector processing block 911. For example, identification may be based on frequency, amplitude and spectral characteristics of the sound source vectors (Ss) in view of the location gain location vectors and parameters, such as an RDS data signal provided from the parameter input controller 905. Accordingly, the signal classifier block 910 may perform classification of one or more audio sources included in each of the respective perceptual locations in the user perceived sound stage. Classification may be based on comparison, such as with a library of predefined sound sources, frequencies or tonal characteristics. Alternatively, or in addition, classification may be based on frequency analysis, tonal characteristics, or any other mechanism or technique for performing source classification. For example, classification of sound sources may be based on extraction and/or analysis of reverberation content included in the input signals, use of an estimation of the noise included in the input signals, detection of speech included in the input signals, detection of a particular audio source included in the input signal based on known distinguishing characteristics of the audio source, such as relatively sudden onset characteristics of a drum.

The signal classifier block 910 may cause the vector processing block 911 to assign a given sound source within a given spatial slice 924 to a given output channel. For example, a vocal signal may be assigned to a given output channel (e.g. the center output channel) regardless of where the vocal signal was located in the user perceived soundstage. In another example, a signal identified as conversational speech (such as talk) may be assigned to more than one output channel in order to obtain a desired sound field, such as to be more pleasing, increase intelligibility, or for any other reason.

In FIG. 9, the classification of the spatial slices 924 may be provided as feedback audio classification signals to each of: the locational filter bank generation block 913, the perceptual model 915, the source model 916 and the genre detection block 917. The feedback audio source classification signals may include identification of each perceptual location across a user perceived sound stage, and identification of one or more audio sources included in each perceptual location. Each of the blocks may use the feedback audio source classification signals in performing their respective processing of subsequent snapshots of the audio input signal.

For example, the locational filter bank generation block 913 may adjust an area of the perceptual location by adjustment of the location and/or the width of the output filters in the locational filter bank in order to capture all, or substantially all, of the frequency components of a given sound source within a predetermined number of spatial slices 924, such as a single spatial slice 924. For example, the location and/or the width of a spatial slice 924 may be adjusted by adjustment of the crossover points of the filters in the locational filter bank to track and capture an identified audio source within an audio input signal, such as an audio source identified to be a vocal signal. The perceptual model 915 may use the audio source classification signals to adjust masking estimates based on predetermined parameters. Example predetermined parameters include whether or not the sound source has a strong harmonic structure, and/or whether the sound source has sharp onsets. The source model 916 may use the feedback audio source classification signals to identify the audio sources in the spatial slices 924 of the user perceived sound stage. For example, where the feedback audio source classification signals indicate voice audio sources in some perceptual locations, and music audio sources in other perceptual locations, the source model 916 may apply voice and music based models to the different perceptual locations of the audio input signal.

The signal classifier block 910 may also provide indication of the classification of the spatial slices 924 on a classifier output line 918. The classification data output on the classifier output line 918 may be any format compatible with the receiver of the classification data. The classification data may include identification of the spatial slice 924 and indication of the sound source(s) contained within the respective spatial slice 924. The receiver of the classification data may be a storage device having a database or other data retention and organization mechanism, a computing device, or any other internal block or external device or block. The classification data may be stored in association with other data such as the audio data for which the classification data was generated. For example, the classification data may be stored in a header or a side chain of the audio data. Offline or realtime processing of the individual spatial slices 924 or the totality of the spatial slices 924 in one or more snapshots may also be performed using the classification data. Offline processing may be performed by devices and systems with computing capabilities. Once stored in association with the audio data, such as in the header or side chain, the classification data may be used as part of the processing of the audio data by other devices and systems. Realtime processing by other computing devices, audio related devices or audio related systems may also use the classification data provided on the output line 918 to process the corresponding audio data.

The genre detection block 917 may use the audio source classification signals to identify the genre of an audio input signal. For example, where the audio source classification signals indicate only voice in the different perceptual locations, the genre can be identified by the genre detection block 917 as talk.

The gain vector generation block 909 may generate the gain location vectors on gain vector output lines 919 for receipt by the vector processing block 911. The vector processing block 911 may also receive the audio input signals 906 as feed forward audio signals on the audio input signal feed forward lines 920. In FIG. 9, the feed forward audio signals are in the frequency domain, in other examples, the vector processing block 911 may operate in the time domain, or in a combination of the frequency domain and the time domain, and the audio input signals may be provided to the vector processing block 911 in the time domain.

The vector processing block 911 may apply the gain location vectors to the audio input signal (feed forward signals) in each of the frequency bins to generate the sound source vectors (Ss) for each spatial slice 924 across the user perceived sound stage. Individual and independent processing of the sound source vectors (Ss) may also be performed within the vector processing block 911. For example, individual sound source vectors (Ss) may be filtered, or amplitude adjusted prior to being output by the vector processing block 911. In addition, effects may be added to certain of the sound source vector (Ss), such as additional reverb may be added to the singer's voice. Individual sound source vectors (Ss) may also be independently delayed, or altered, reconstructed, enhanced, or repaired as part of the processing by the vector processing block 911. The sound source vectors (Ss) may also be smoothed or otherwise individually processed prior to being output by the vector processing block 911. In addition, the sound source vectors (Ss) may be assembled, such as combined or divided, by the vector processing block 911 prior to being output. Accordingly, original recordings may be “adjusted” to improve the quality of the playback based on the level of individual spatial slice adjustments.

Following processing with the vector processing block 911, the processed sound source vectors (Ss) may be output as sound source vector signals on the vector output lines 921. Each of the sound source vector signals may be representative of one or more separate audio sources from within the audio input signal. The sound source vector signals may be provided as input signals to the signal classifier block 910 and the post-processing block 902.

The parameter input controller 905 may selectively provide parameter inputs to the gain vector generation block 909, the signal classifier block 910, and the vector processing block 911. The parameter inputs may be any signal or indication useable by the blocks to influence, modify and/or improve the processing to generate the gain location vectors and/or the processed sound source vectors (Ss). For example, in the case of a vehicle, the parameter inputs may include external signals such as engine noise, road noise, microphones and accelerometers located inside and outside the vehicle, vehicle speed, climate control settings, convertible top up or down, volume of the sound system, RDS data, the source of the audio input signals, such as a compact disc (CD), a digital video decoder (DVD), AM/FM/satellite radio, a cellular telephone, a Bluetooth connection, an MP3 player, or any other source of audio input signals. Other parameter inputs may include an indication that the audio signal has been compressed by a lossy perceptual audio codec, the type of codec used (such as MP3), and/or the bitrate at which the input signal was encoded. Similarly, for the case of speech signals, parameter inputs may include an indication of the type of speech codec employed, the bitrate at which it was encoded, and/or an indication of voice activity within the input signal. In other examples, any other parameters may be provided that are useful for audio processing.

Within the gain vector generation block 909, the parameter inputs may provide information for the genre detection block 917 to detect the genre of the audio input signal. For example, if the parameter inputs indicate that the audio input signal is from a cell phone, the genre detection block 917 may indicate the audio input signal is a voice signal. Parameter inputs provided to the signal classifier 910 may be used to classify the individual audio sources in the spatial slices 924. For example when the parameter inputs are indicating the audio source is a navigation system, the signal classifier 910 can look for spatial slices 924 that include a voice as the audio source and ignore the other spatial slices 924. In addition, the parameters may allow the signal classifier 910 to recognize noise or other audio content included in a particular spatial slice 924 with an audio source. The vector processing block 911 may adjust processing of the spatial slices 924 based on the parameters. For example, in the case of a vehicle, the parameter of speed may be used to increase the amplitude of low frequency audio sources, or certain spatial slices 924, or certain sound source vectors at higher speeds.

In FIG. 9, the sound source vector signals may be processed through the post-processing block 902 to convert from the frequency domain to the time domain using processes similar to the pre-processing block 9. Thus, the post-processing block 902 may include a converter 922 and a windowing block 923 the sound source vector signals. The converter 922 and the windowing block 923 may use a Discrete Fourier Transform (DFT), or other transformation process to convert the blocks of time samples. In other examples, different frequency domain to time domain conversion processes may be used. In still other examples, the sound source vector signals provided on the vector output lines 921 may be in the time domain due to processing with the sound source vector processing block 904 being at least partially performed in the time domain, and the post processing block 902 may be omitted. The sound source vector signals, or post-processed sound source vector signals, are representative of the audio sources divided into the spatial slices 924 and may be subject to further processing, may be used to drive loudspeakers in a listening space, or may be used for any other audio processing related activities

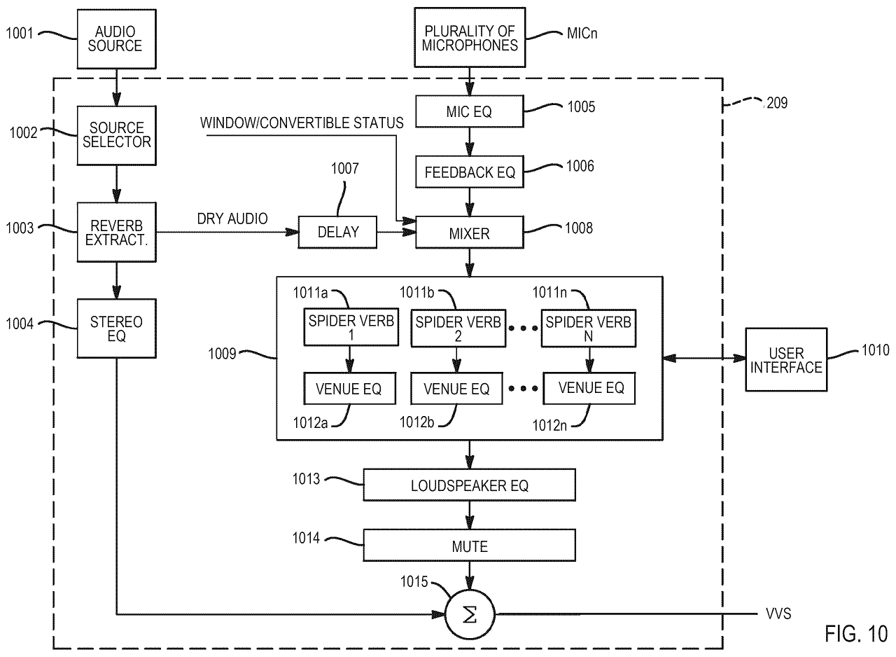

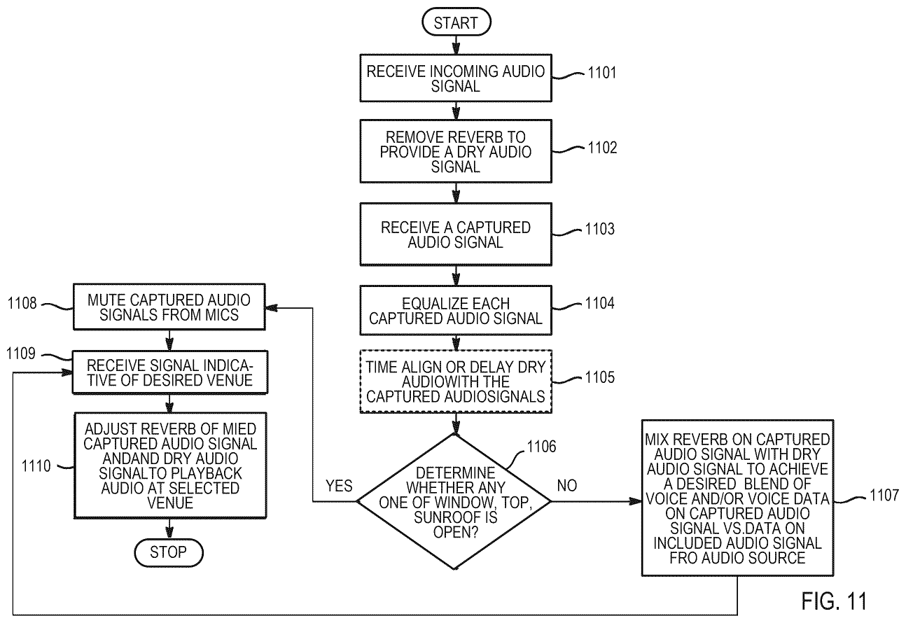

An example of an ambience generation process is described below in connection with FIGS. 10 and 11 and is detailed in U.S. Pat. No. 10,728,691B2, assigned to the assignee of the present disclosure, and incorporated herein by reference. FIG. 10 depicts an example process for generating an ambience 209 by generating virtual venues within a listening environment such as a vehicle interior. An audio source 1001 is configured to provide an incoming audio signal to the vehicle audio controller (not shown). The audio source 1001 may be any one of an FM station, an AM station, a High Definition (HD) audio station, a satellite radio provider, an input from cell phone, an input from a tablet, etc. The user may select the corresponding audio source 1001 via a source selector 1002 positioned on the vehicle audio controller or via a user interface (not shown) which may be implemented elsewhere in the vehicle or a mobile device (not shown).

A reverb extraction block 1003 (or extraction block 1003) removes reverb from the incoming audio signal to provide a dry audio signal. This operation is performed to prepare the incoming audio signal to receive the corresponding reverberation effect for the selected venue. It is recognized that the reverb extraction block 1003 may not be capable of completely removing the reverb from the incoming audio signal and that some remnants of reverb may still be present on the dry audio signal. A stereo equalization block 1004 receives the dry audio signal from the reverb extraction block 1003. The stereo equalization block 1004 may serve as a regular stereo equalizer in the vehicle and is configured to equalize the incoming audio signal for user playback.

The virtual venues process receives an input from each corresponding microphone in the vehicle such as microphones MICn shown in FIG. 3. The audio captured by the microphones M may correspond to music, speech, and ambient noise within the vehicle interior. A microphone equalization block 1005 receives the captured audio from the microphones MICn and equalizes (i.e., boosts or weakens the energy of various frequency bands) the captured audio. A feedback equalization block 1006 receives an output from the microphone equalization block 1005. The process 209 further includes a delay block 1007, an audio mixer 1008, and a spider reverb block 1009. The delay block 1007 receives the dry audio from the extraction block 1003 to time align the dry audio with the captured audio from the microphones MICn. This condition accounts for the delay of processing the incoming audio signal by the ambience generation process 209 (cf. FIG. 2). It is desirable to ensure that the playback of the entertainment data on the incoming audio signal is time aligned with the captured audio signal from the microphones MICn. Consider the example in which vehicle occupants are clapping or singing along with the entertainment data of the incoming audio signal, in this case it is desirable to time align the playback of the entertainment data on the incoming audio signal with the clapping or vocal inputs from the vehicle occupants (as captured by the microphones MICn) for playback. By capturing the playback of the entertainment data of the incoming audio signal and the clapping or vocal inputs (or other actions performed by the vehicle occupant(s) that coincide with entertainment data) by the microphones MICn, this aspect further provides the experience to the vehicle occupant(s) that he/she is located within the desired venue as one would expect to hear to some extent noise that coincides with the audio playback at a venue that includes an audience. Thus, by capturing the ambient noise in the vehicle interior with the microphones MICn and combining this data with the entertainment data of the incoming audio signal and subsequently adjusting the reverb of the mix, this aspect enhances the experience for the vehicle occupant and provides the perception that the vehicle occupant is positioned within the desired venue.

The delay block 1007 may or may not apply a delay depending on the processing speed of the process. The mixer 1008 is configured to mix the reverb from the audio captured by the microphones MICn with any remnants of reverb that are left on the on the incoming audio signal. The mixer 1008 receives a signal WINDOW/CONVERTIBLE STATUS that indicates whether the window, convertible top, or sun roof is open or closed. Again, the mixer 1008 may mute the captured signal from the microphones MICn if the window, convertible top, or sun roof is open and too much noise is on the signal. Likewise, the mixer 1008 controls how much noise or voice data (i.e., captured audio data from the plurality of microphones MICn) in the vehicle interior is fed back to the spider verb block 1009 versus how much audio is fed into the spider verb block 1009. In general, the mixer 1008 determines the blend of audio captured at the microphone MICn in relation to direct audio (or the dry audio) in order to achieve a desired blend.

A user interface 1010 provides a control signal to the process 209 that indicates a selected venue (or virtual venue) for the process 209 to playback the audio. As noted above, the selected venue may correspond to any one of a stadium, a concert hall (e.g., large, small, or medium), recording studio)), and a listening environment of a vehicle interior that is different from the listening environment of the vehicle that the user is positioned in. The spider reverb block 1009 receives an output from the mixer 1008 that corresponds to the mixed dry audio and the captured audio. The spider reverb block 1009 generally includes a plurality of spider verb blocks 1011a-1011n (or “1011”) and a plurality of venue equalization blocks 1012a-1012n (or “1012”). In general, each spider verb block 1011 and its corresponding venue equalization block 1012 adds or adjusts the amount of reverb on the output from the mixer 1008 to provide the selected or desired venue for the user. Specifically, the spider reverb block 1011 replicates different reverberation characteristics of the different walls for the selected venues. The spider verb block 1009 adjusts the reverberation to correspond to a designated or selected venue and the venue equalization block 1012 controls the brightness characteristics for the walls of the vehicle interior to provide the desired brightness characteristics for the selected venue. The selected venue may correspond to a stadium venue, a large concert hall, a medium concert hall, and so on. For example, in the event the user selected that the process 209 playback the audio as if the user was positioned in Carnegie Hall, the spider verb block 1011 is configured to provide reverberation effect off the walls of the vehicle interior to sound like the walls of Carnegie Hall. This gives the user the perception that he/she is actually listening to audio in Carnegie Hall while actually sitting in the vehicle. The process 209 includes storing in a memory (not shown) any number of desired venues and that may also take into account the various front, side, rear, and top walls of the selected venues and the manner in which the audio reflects or echoes off such surfaces of the walls. For example, the memory may include storing various pre-set frequency values that correspond to a characteristics of the walls for particular venue and the venue equalization block 1012 may boost or decrease frequency levels of the audio output from the mixer 1008 and the spider verb block 1011 to further increase the perception that the user is actually located in the corresponding or selected venue.

For example, consider the scenario in which the selected venue generally provides a short ceiling that is made of metal and far away walls that have carpet on them. The ceiling may have very bright and fast reflection characteristics in comparison to the other wall that would sound very dull and have slower reflection times. The spider reverb block 1009 adjusts the reverberation of the incoming audio signal and the captured audio signal to provide the desired venue and the corresponding venue equalization block 1012 controls the equalization of the incoming audio signal and the captured audio signal to simulate playback in the desired venue and to simulate the brightness characteristics of walls of the desired venue. In general, the speakers in the vehicle globally provide an output that corresponds to a desired venue and corresponding speaker(s) in a given wall may each receive a discrete input to simulate the desired brightness characteristic for that given wall of the desired venue. For example, speakers in the ceiling of the vehicle may receive an equalized output to provide the appearance that the sound that bounces off of the ceiling has a fast reflection time to coincide with the short ceiling of the selected venue as noted above. Likewise, the equalization may be adjusted differently for each audio output provided to a corresponding speaker in a particular wall to coincide with various walls in the selected venue.

A speaker equalization block 1013 receives an output from the spider verb block 1009 to provide a more even audio response in the vehicle interior. The speaker equalization block 1013 compensates for issues with the speakers in the vehicle. A mute block 1014 is provided to simply remove the amount of reverb added by the spider verb block 1009 if the user elects to hear the incoming audio in a normal mode. The user interface 1010 may transmit a signal indicative of a request to the vehicle audio controller 26 to disable the reverberation effect that is added to obtain the selected venue. In response to the request, the process 209 may activate the mute block 1014 to simply disable the playback of the audio in the selected venue. An adder 1015 receives the output from the spider reverb block 1009 (or from the mute block 1014) and also receives the output from the stereo equalization block 1004 and sums the two audio inputs together to provide a virtual venue output signal VVS, e.g., to the source distribution block 210.

FIG. 11 generally depicts a method for generating the virtual venues within the listening room using the process structure of FIG. 10. The operations as noted in connection with FIG. 11 may be performed in any order and it is noted that various operations may be performed concurrently with one another. The order of the operations as performed may vary based on a particular implementation.

In operation 1101, the process 209 receives an incoming audio signal from the audio source 1001. As noted above, the audio source 1001 may correspond to any one of an FM radio station, a High Definition (HD) audio station, a satellite radio provider, an input from cell phone, an input from a tablet, MP3 player, or any other source that provides entertainment data in conjunction with the provided audio signals. In general, the incoming audio signal may correspond to audio data that is to be played back to entertain vehicle occupants in the vehicle.

In operation 1102, the process 209 removes reverb from the incoming audio signal in order to provide a dry audio signal.

In operation 1103, the process 209 receives a captured audio signal from each microphone MICn in the vehicle interior. For example, a vehicle audio controller, such as the audio processing system shown in FIG. 1, boosts or weakens the energy of various frequency bands for each captured audio signal. As noted above, the captured audio signal generally corresponds to music, noise captured from vehicle occupants that corresponds to the entertainment data on an incoming audio signal including entertainment data from an electronic audio source, speech (or dialogue from vehicle occupants), and/or ambient noise from exterior of the vehicle that enters into the vehicle interior, ambient noise from within a vehicle cabin, etc.

In operation 1104, the process 209 equalizes each captured audio signal. For example, the process 209 boosts or weakens the energy of various frequency bands of the captured audio signal.

In operation 1105, the process 209 may optionally employ time delay or delay the transmission of the dry audio signal with the captured audio signal to ensure that the playback of the entertainment data on the dry audio signal coincides with the captured audio signal.

In operation 1106, the process 209 determines whether any one of a window, convertible top, and sun roof is open. If the process 209 determines that any one of the window, the convertible top, and the sun roof is closed, then the method moves to operation 1107. If the process 209 determines that any one of the window, the convertible top, and the sun roof is open, then the method moves to operation 1108.

In operation 1107, the process 209 mixes the reverb on the captured audio signals with the dry audio signal to achieve a desired blend of noise, music and/or voice information on the captured audio signal versus entertainment data on the incoming audio signal as received from the audio source 1001.

In operation 1108, the process 209 mutes the captured audio signal as such a signal carries too much noise (e.g., environmental noise such as wind, road noise, etc.) given that one of the one of the window, the convertible top, and the sun roof is open. In this case, the process in operation 1109 may simply adjust the reverb of the incoming audio signal from the audio source 1001 to playback back the incoming audio signal at the selected venue in the vehicle interior.

In operation 1109, the process 209 receives a control signal indicative a desired venue to be simulated in the vehicle interior during audio playback.

In operation 1110, the process 209 adjusts the reverb of the mixed captured audio signal and the dry audio signal to playback entertainment data on the incoming audio signal from the audio source 1001 at the selected venue in the vehicle interior. In addition, the process 209 equalizes the frequency of the mixed captured audio signal and the dry audio signal to provide the desired brightness characteristic for the various walls of the selected venue.

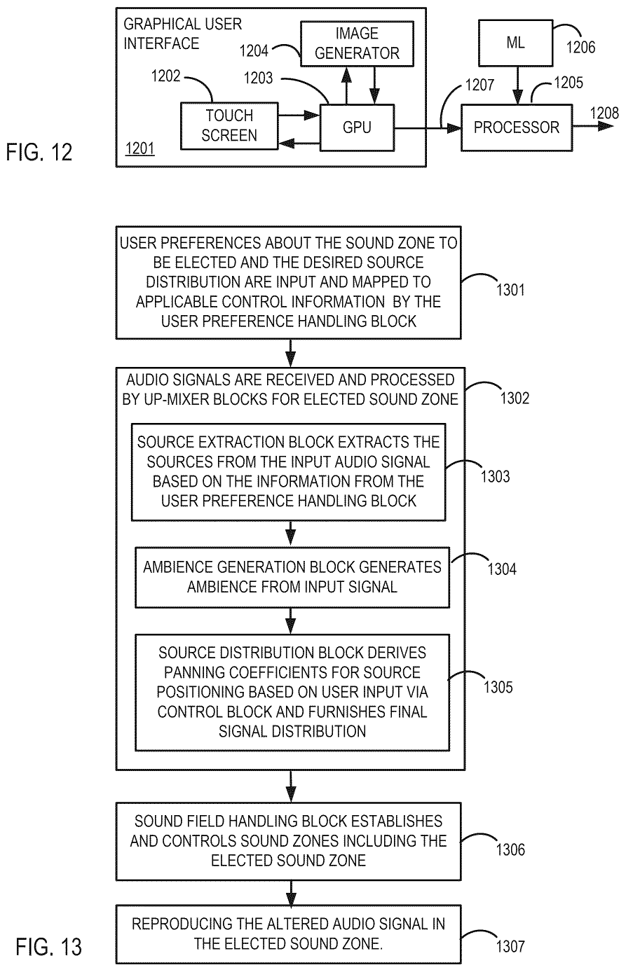

An example of a user preference handling process is described below in connection with FIG. 12. The user preference handling process shown in FIG. 12 employs a graphical user interface (GUI) 1201 which includes, for example a touch screen 1202 for visual/haptic interaction with the user, at least one graphics processor unit (GPU) 1203 for driving and controlling the touch screen 1202, and an image generator 1204 which provides not only visual user guidance but also a graphical representation of the listening room or the sound zone selected by the user to be displayed on the touch screen 1202. For example, the user may move by way of a touch function of the screen 1202 graphical representations of extracted original sources to desired positions in the graphical representations of the listening room displayed using a visual function of the screen 1202. The representations are generated by the image generator 1204. The graphics processor 1203 translates the positions of the graphical representations of the extracted sources on the screen 1202 into position data 1207 in the listening room.

At least one processor 1205 translates the position data 1207 into control signals 1208 for control of acoustically relevant parameters such as source distribution control signals and ambience control signals which control, e.g., filter parameters, delay times, interconnection structure of filters. For the translation of the position data 1207 into control signals 1208 for control of acoustically relevant parameters artificial intelligence such as a machine learning (ML) algorithm 1206 may be employed, which assigns certain desired positions of the virtual sources to certain auditory impressions. The ML algorithm 1206 is trained with a large variety of audio signals and for a very large number of users. The user preference handling process shown in FIG. 12 maps the user preferences input into the touch screen 1202 in relation to the output virtual source distribution to appropriate parameters for the 3D rendering. Although shown as individual blocks in FIG. 12, some functions shown there may be combined into one block and all functions except those of the touch screen 1202 may also be combined into one block, for example, as in the graphic processor unit 1203.

FIG. 13 shows a possible work flow for implementing the sound reproduction methods described above, wherein the methods include at least the operations of (a) receiving one or more input audio signals representative of audio content to be reproduced, (b) generating at least two sound zones using multiple loudspeakers, the multiple loudspeakers being configured, positioned and operated to spatially limit audibility of audio content to be reproduced to one of the at least two sound zones, and (c) reproducing in the one of the at least two sound zones the audio content to be reproduced using at least some of the multiple loudspeakers, wherein the at least some of the multiple loudspeakers are configured, positioned and operated to generate from the input audio signal sound that creates three-dimensional audio effects, the three-dimensional audio effects including placement of virtual sound sources anywhere in a three-dimensional space, and the three-dimensional space being the one of the at least two sound zones. These operations (a)-(c) may be performed in any order and it is intended that various operations may be performed concurrently with one another. The order of the operations as performed may vary dependent on the requirements of the particular implementation. FIG. 13 is an example implementation of one such method including the following procedures:

Procedure 1301: User preferences about the sound zone to be elected and the desired source distribution are input and mapped to appropriate control information (for e.g. the coordinates of the respective sources, number of sources to be extracted etc.) by the user preference handling block. The users may use an interface, e.g., a graphical user interface (GUI), by means of which he/she can select the vocals and instruments for example.

Procedure 1302: Audio signals are received and processed by up-mixer blocks for the selected sound zone. Procedure 1302 includes the sub-procedures 1303-1305:

Sub-procedure 1303: The source extraction block extracts the sources from the input audio signal based on the information from the user preference handling block.

Sub-procedure 1304: The ambience generation block generates the ambience from the input signal.

Sub-procedure 1305: The source distribution block derives the panning coefficients for the source positioning based on the user input via the control block and furnishes the final signal distribution.

Procedure 1306: The sound field handling block establishes and controls the sound zones including the elected sound zone.

Procedure 1307: Reproducing the altered audio signal in the elected sound zone.

Under typical conditions in a vehicle interior, an up-mixing rendering process may be merged with a sound zones process in which each sound zone is focused on a specific location, e.g., seat, thereby enriching the personalized immersive audio experience for all the passengers. The input single-channel or multi-channel audio signal is processed by up-mixer blocks in the sound zones. The source extraction block extracts the sources from the input audio signal based on the information from the user preference evaluation block. The ambience generation block generates the ambience from the input signal. The source distribution block derives the panning coefficients for the source positioning based on the user input via the control block and takes care of the final signal distribution. The user may input his/her preferences employing an interface (e.g., a visual interface) where he/she can adjust, for example, the positions of the vocals and instruments on a (touch) screen. The interface generates corresponding virtual source distribution parameters based on the desired source distribution as depicted on the screen and the source distribution block generates a 3D virtual source distribution based on the virtual source distribution parameters. Additionally, the disclosure also proposes to enhance the “personalization” by using an intelligent source distribution algorithm, thereby enhancing the user experience.

This allows every user to experience the 3D audio rendering in the best possible way in vehicles or any other listening room, which is not the case at present. The existing technologies are focused on dedicated listening positions or sweet-spots and the proposed idea overcomes this limitation by combining the 3D audio technologies with sound zones. Personalized 3D audio experience is available for all users, with no “sweet spot” limitation, and the rendering is tailored for dedicated sound zones. Audio rendering is further enhanced with the involvement of the end user in the source distribution using intelligent source panning. Every user can listen to the immersive audio rendering in the unique way each of them prefer.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While various embodiments of the disclosure have been described, it will be apparent to those of ordinary skilled in the art that many more embodiments and implementations are possible within the scope of the disclosure. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

What is claimed is:

1. A method comprising:
receiving an input audio signal representative of audio content;
generating at least two sound zones using multiple loudspeakers, the multiple loudspeakers being configured, positioned and operated to spatially limit audibility of the audio content to one of the at least two sound zones; and
reproducing the audio content in the one of the at least two sound zones using at least some of the multiple loudspeakers, wherein the at least some of the multiple loudspeakers are configured to generate sound from the input audio signal that creates a three-dimensional audio effect, the three-dimensional audio effect comprising placement of a virtual sound source in a three-dimensional space, the three-dimensional space comprising the one of the at least two sound zones.

2. The method of claim 1, wherein reproducing the audio content comprises:
analyzing the received input audio signal to identify an original sound source and an original position corresponding to the original sound source; and
extracting a dry audio signal of the original sound source from the input audio signal and a corresponding position signal of the original sound source.

3. The method of claim 2, wherein extracting the dry audio signal of the original sound source and the corresponding position signal of the original sound source comprises extracting at least one of: a center dry signal, vocal dry signal, instrumental dry signal, dry residual signal of the original sound source, or the corresponding position signal.

4. The method of claim 2, wherein reproducing the audio content comprises:
receiving an ambience control signal representative of a desired ambience;
generating an ambience signal based on the ambience control signal; and
adding the ambience signal to the audio content.

5. The method of claim 4, wherein generating the ambience signal comprises generating an early reflection of the virtual sound source.

6. The method of claim 4, wherein generating the ambience signal comprises generating reverberations of the virtual sound source.

7. The method of claim 2, wherein reproducing the audio content comprises:
receiving a source distribution control signal representative of a desired virtual source distribution; and
generating, from the dry audio signal of the original sound source and the corresponding position signal of the original sound source, the virtual sound source at a virtual sound source position in the audio content based on the source distribution control signal and the dry audio signal of the original sound source.

8. The method of claim 1, wherein the input audio signal has a first number of channels and wherein reproducing the audio content comprises up-mixing the input audio signal to a second number of channels, wherein the second number of channels is greater than the first number of channels.

9. The method of claim 7, wherein up-mixing the input audio signal comprises:
analyzing the received input audio signal to identify the original sound source and the original position; and
extracting the dry audio signal of the original sound source and the corresponding position signal of the original sound source.

10. The method of claim 7, wherein up-mixing the input audio signal comprises:
generating an ambience control signal representative of a desired ambience to be reproduced; and
generating an ambience signal based on the ambience control signal.

11. The method of claim 7, wherein up-mixing the input audio signal comprises generating, from the dry audio signal of the original sound source and the corresponding position signal of the original sound source, the virtual sound source at the virtual sound source position based on the source distribution control signal.

12. The method of claim 2, further comprising receiving user preferences via a user interface and generating at least one of a source distribution control signal or an ambience control signal based on the user preferences.

13. The method of claim 12, wherein generating at least one of the source distribution control signal or the ambience control signal based on the received user preferences comprises mapping, using a machine learning model, the user preferences related to the virtual source position to the source distribution control signal.

14. The method of claim 12, wherein the user preferences are received from a graphical user interface which generates position data corresponding to a desired position of the virtual source.

15. The method of claim 1, wherein generating the at least two sound zones comprises matrix-wise inverse filtering of signals to be reproduced by the multiple loudspeakers.

16. A sound reproduction system comprising:
a plurality of loudspeakers;
a multi-channel amplifier configured to drive the plurality of loudspeakers; and
at least one processor configured to drive the amplifier, the at least one processor being configured to execute instructions to perform the steps of:
receiving an input audio signal representative of audio content;
generating at least two sound zones using multiple loudspeakers, the multiple loudspeakers being configured, positioned and operated to spatially limit audibility of the audio content to one of the at least two sound zones; and
reproducing the audio content in the one of the at least two sound zones using at least some of the multiple loudspeakers, wherein the at least some of the multiple loudspeakers are configured to generate sound from the input audio signal that creates a three-dimensional audio effect, the three-dimensional audio effect comprising placement of a virtual sound source in a three-dimensional space, the three-dimensional space comprising the one of the at least two sound zones.

17. The sound reproduction system of claim 16, wherein the at least some of the plurality of loudspeakers are disposed around the one of the at least two sound zones.

18. The sound reproduction system of claim 16, further comprising a touch screen user input device.

19. The sound reproduction system of claim 16, wherein reproducing the audio content comprises:
analyzing the received input audio signal to identify an original sound source and an original position corresponding to the original sound source; and
extracting a dry audio signal of the original sound source from the input audio signal and a corresponding position signal of the original sound source.

20. The sound reproduction system of claim 16, wherein the input audio signal has a first number of channels and wherein reproducing the audio content comprises up-mixing the input audio signal to a second number of channels, wherein the second number of channels is greater than the first number of channels.
